(19) United States
(12) Patent Application Publication
(10) Pub. No.: US 2005/0069440 A1
(43) Pub. Date: Mar. 31, 2005

(54) Multistage dry pump

(75) Inventor: Yoshihiro Naito, Nagoya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/948,245

(22) Filed: Sep. 24, 2004

(30) Foreign Application Priority Data
Sep. 25, 2003 (JP) 2003-332964

(51) Int. Cl. F03C 2/00

(52) U.S. Cl. 418/9

(57) ABSTRACT

A multistage dry pump includes a pump housing having plural pump chambers aligned in parallel, a rotational shaft extending along a parallel alignment direction of the plural pump chambers and rotatably supported by the pump housing, and plural rotors parallelly aligned in an axial direction of the rotational shaft and furnished in the respective plural pump chambers. The rotational shaft is formed with a base material of which linear expansion coefficient is less than 6×10⁻⁶ m/m·K inclusive, and the respective plural rotors is made of a material which is more easily machined than the material of the rotational shaft.

### CROSS REFERENCE TO RELATED APPLICATIONS

This application is based on and claims priority under 35 U.S.C. §119 with respect to a Japanese Patent Application 2003-332964, filed on Sep. 25, 2003, the entire content of which is incorporated herein by reference.

### FIELD OF THE INVENTION

This invention generally relates to a multistage dry pump having rotor rotational member which supports plural rotors parallelly aligned in an axial direction of a rotational shaft. The multistage dry pump keeps a pump chamber depressurized while restraining an amount of lubricating oil in the pump chamber.

### BACKGROUND

A conventional multistage dry pump includes a pump housing having plural pump chambers aligned in parallel therein, and a pair of rotor rotational members furnished in the plural pump chambers. The rotor rotational members are provided with a rotational shaft rotatably supported by the pump housing and plural rotors parallelly aligned in an axial direction of the rotational shaft. The pair of rotor rotational members rotates in one and the other rotational directions at a relatively high rotational speed. Gas drawn at a main intake port of the pump housing is compressed in sequence in response to the rotation of the pair of rotor rotational members and is exhausted from a main outlet port.

In the pair of rotor rotational members, the rotors rotate having a small clearance between each rotor and between each rotor and an inner wall surface of the pump housing. In this type of multistage dry pump, it is preferable that this clearance is kept as small as possible in order to enhance pumping performance such as ultimate vacuum and exhausting speed.

Further, when this type of multistage dry pump is used at various production processes such as a semiconductor production process and a liquid crystal component production process, it is also preferable that the pump is operated in the pump chambers at a relatively high temperature. For example, gas, which tends to deposit reaction product therefrom, and condensable gas may be drawn from the main intake port and exhausted from the main outlet port through various production processes such as a semiconductor production process and a liquid crystal component production process. In this case, it is preferable that the gas passes through the pump inside without being liquefied or condensed. On the other hand, if gas liquefaction or gas-condense occurs in the pump inside, the rotors may be interrupted from smoothly rotating. Therefore, it is preferable that the pump chamber inside is maintained at a relatively high temperature and so the gas liquefaction or gas-condense can be effectively restrained.

However, when the pump is operated in the pump chambers at a relatively high temperature, gas is compressed with heat. The heat of gas compression can be a factor of rises in temperatures of the rotor rotational members and pump housing. Especially, the rotor rotational members, which are furnished in the pump chambers, shows a larger temperature increase rather than an outside surface of the pump housing. Due to the heat expansion of the rotor rotational members, the clearance described above may not be assured sufficiently. As a result, each rotor may impact with an inner wall surface of each pump chamber of the pump housing, thereby causing a rotor lock, i.e., interrupting each rotor from smooth rotation.

As described in JP05 (1993)-18379A2 and JP08 (1996)-296557A2, a processing or assembling error in the axial direction of the rotational shaft is offset not by using a joint such as a key or bolt but by integrating the rotational shaft and rotors as the rotor rotational member. Therefore, the processing or assembling precision is enhanced. Further, the clearance between each rotor and the clearance between the rotor and the inner wall surface of the pump chamber is preferably designed with the heat expansion due to the temperature raise in mind.

As described above, the smaller the clearance is designed, the more the gas counter-flow is prevented. Therefore, the pumping performance in the multistage dry pump can be improved. However, the rotor is made of an aluminum alloy, a cast-iron material or a steel material such as S45C steel, each of which has a property of a large heat expansion coefficient. In this case, while the pump has been operated, at the pump chambers at a relatively high temperature, the rotor and the inner wall surface of the pump chamber may impact with each other. This sort of impact may occur especially in the axial direction of the rotational shaft, which is longer than a radial direction thereof. In light of foregoing, the temperature raise of the pump chamber beyond a certain temperature level is not preferable. However, if the temperature of the multistage dry pump is not raised that much, the condensable gas or the gas, which tends to generate reaction product, may get easily liquefied or condensed in the pump. The gas liquefaction or condense may deteriorate a smooth rotation of the rotor.

According to the other conventional multistage dry pump, the rotor itself shaped like an egg is made of an austenite cast iron with a property of a small linear expansion coefficient. However, the austenite cast iron is a viscous material and cannot be easily cut or machined. To the contrary, the rotor itself is required to have complex profile. Further, accurate process is required to have a small clearance between each rotor and between the rotor and the inner wall surface of the pump chamber, thereby deteriorating productivity of the rotor and unnecessarily increasing the manufacturing cost thereof.

A need exists for providing a multistage dry pump at which each component is less expanded with heat while increasing the temperature of the pump chamber, thereby restraining occurrence of a rotor lock due to the heat expansion between the rotor and the inner wall surface of the pump chamber of the pump housing. Further, a need exists for providing a multistage dry pump which is provided with a rotor appropriately machined to have a complex profile at a high machining precision and can be manufactured at a less manufacturing cost.

### SUMMARY OF THE INVENTION

According to an aspect of the present invention, a multistage dry pump includes a pump housing having plural pump chambers aligned in parallel, a rotational shaft extending along a parallel alignment direction of the plural pump chambers and rotatably supported by the pump housing, and plural rotors parallelly aligned in an axial direction of the rotational shaft and furnished in the respective plural pump chambers. The rotational shaft is formed with a base material of which linear expansion coefficient is less than 6×10⁻⁶ m/m·K inclusive, and the respective plural rotors is made of a material which is more easily machined than the material of the rotational shaft.

### BRIEF DESCRIPTION OF THE DRAWINGS

The foregoing and additional features and characteristics of the present invention will become more apparent from the following detailed description considered with reference to the accompanying drawings, wherein:

FIG. 1 is a cross sectional view illustrating a multistage dry pump cut away in an axial direction thereof according to a first embodiment of the present invention;

FIG. 2 is a cross sectional view illustrating the multistage dry pump in FIG. 1 taken along a line II-II;

FIG. 3 is a cross sectional view illustrating one rotor rotational member cut away in an axial direction of the rotor rotational member;

FIG. 4 is a cross sectional view illustrating the other rotor rotational member cut away in an axial direction of the other rotor rotational member;

FIG. 5 is a perspective view schematically illustrating an inner structure of the multistage dry pump according to the first embodiment of the present invention; and

FIG. 6 is a cross sectional view illustrating a multistage dry pump cut away in an axial direction thereof according to a second embodiment of the present invention.

### DETAILED DESCRIPTION

Embodiments of the present invention will be described hereinbelow in detail with reference to the accompanying drawings.

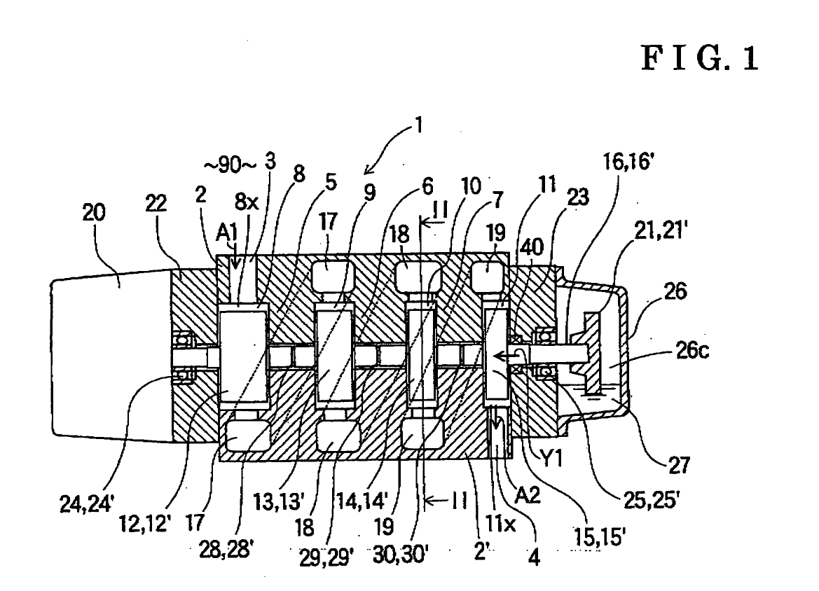

As illustrated in FIG. 1, a multistage dry pump 1 according to a first embodiment of the present invention includes pump housings 2 and 2′ line-split vertically, i.e., line-split up and down in FIG. 1. Hereinafter, a component with a numeral number without an apostrophe mark is one of a pair, while a component with a numeral number with the apostrophe mark is the other one of the pair. An inner space defined by the pump housings 2 and 2′ houses plural pump chambers isolated from each adjacent chamber by each dividing wall. According to the first embodiment of the present invention, the inner space in the pump housings 2 and 2′ houses four pump chambers: a first stage pump chamber 8; a second stage pump chamber 9; a third stage pump chamber 10; and a fourth stage pump chamber 11. The first stage pump chamber 8 is independent from the second stage pump chamber 9 by a dividing wall 5, the second stage pump chamber 9 is independent from the third stage pump chamber 10 by a dividing wall 6, and the third stage pump chamber 10 is independent from the fourth stage pump chamber 11. The fist, second, third and fourth pump chambers 8, 9, 10 and 11 are parallelly aligned in this sequence in a direction from a main intake port 3 to a main outlet port 4. At the pump housing 2, the main intake port 3, of which one opening communicates with a subject chamber 90, is designed to communicate with an intake port 8×of the first stage pump chamber 8 at the other opening. At the pump housing 2′, the main outlet port 4, of which one opening communicates with an atmosphere, is designed to communicate with an outlet port 11x of the fourth stage pump chamber 11 at the other opening.

Volumes of the respective pump chambers 8, 9, 10 and 11 are designed to show a drop in this sequence. Namely, the volume of the first stage pump chamber 8 positioned in the vicinity of the main intake port 3 is the largest among the volumes of the pump chambers, while the volume of the fourth stage pump chamber 11 positioned in the vicinity of the main outlet port 4 is the smallest among them. Therefore, an axial length of each pump chamber 8, 9, 10 and 11 is designed gradually shorter in this sequence. Namely, the axial length of the first stage pump chamber 8 is the longest among the axial lengths of the pump chambers, while the axial length of the fourth stage pump chamber 11 is the shortest among them.

The main reason that the sizes of the respective pump chambers 8, 9, 10 and 11 are designed as described above is as follow. A pressure difference between an intake side of the pump chamber and an outlet side of the pump chamber becomes increased in the sequence of the pump chambers 8, 9, 10 and 11. Namely, the pressure difference between the intake side and the outlet side at the fourth stage pump chamber 11 is larger than the ones at the pump chambers 8, 9 and 10. The largest load is hence applied to the fourth stage pump chamber 11 in order to perform pressure-compress. Therefore, the temperature of the fourth stage pump chamber 11 reaches higher than the ones of the pump chambers 8, 9 and 10. In light of foregoing, the load required to the fourth stage pump chamber 11 for the pressure-compress is restrained from being unnecessarily increased compared with the load required to the first stage pump chamber 8, by dropping the volumes of the pump chambers 8, 9, 10 and 11 in this downstream sequence. As a result a difference between heats of compression at the first stage pump chamber 8 and the fourth stage pump chamber 11 can be restrained from being unnecessarily increased, As illustrated in FIG. 1, the pair of pump housings 2 and 2′ are substantially symmetrically oriented up and down in FIG. 1 along an axial direction of rotational shafts 16 and 16′.

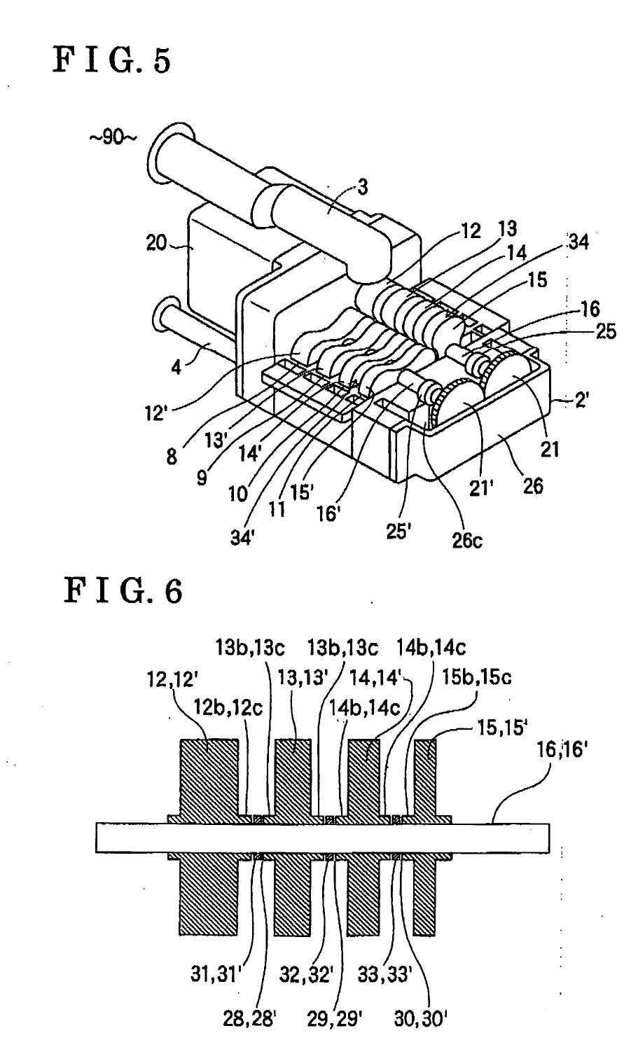

As illustrated in FIG. 5, a pair of first stage rotors 12 and 12′ is rotatably equipped about the pair of rotational shafts 16 and 16′ in the first stage pump chamber 8. A pair of second stage rotors 13 and 13′ is rotatably equipped about the pair of rotational shafts 16 and 16′ in the second stage pump chamber 9. A pair of third stage rotors 14 and 14′ is rotatably equipped about the pair of rotational shafts 16 and 16′ in the third stage pump chamber 10. A pair of fourth stage rotors 15 and 15′ is rotatably equipped about the pair of rotational shafts 16 and 16′ in the fourth stage pump chamber 11. Each rotor 12, 12′, 13, 13′, 14, 14′, 15 and 15′ has a sectional shape like a pair of circles being in contact with each other, i.e., has a two bladed configuration. More particularly, both ends of each rotor are of half annular shaped and both sides of each rotor are recessed inwardly. That is, each rotor can be referred to as a two bladed rotor.

As illustrated in FIG. 1, the first stage pump chamber 8 communicates with the second stage pump chamber 9, which is positioned axially adjacent to the first stage pump chamber 8, via a gas transport passage 17. The second stage pump chamber 9 communicates with the third stage pump chamber 10, which is positioned axially adjacent to the second stage pump chamber 9, via a gas transport passage 18. The third stage pump chamber 10 communicates with the fourth stage pump chamber 11, which is positioned axially adjacent to the third stage pump chamber 10, via a gas transport passage 19. Therefore, the gas drawn from the main intake port 3 in an arrow direction A1 is sequentially compressed four times and exhausted from the main outlet port 4 in an arrow direction A2.

As further illustrated in FIG. 1, the pump housings 2 and 2′ are integral with a side cover 22 at the main intake port 3 side, while being integral with a side cover 23 at the main outlet port 4 side. The side cover 22 is provided with bearings 24 and 24′ for supporting one ends of the rotational shafts 16 and 16′ for rotation, while the side cover 23 is provided with bearings 25 and 25′ for supporting the other ends of the rotational shafts 16 and 16′ for rotation. The rotational shaft 16 is rotatably connected to a motor 20 and so acts as a drive shaft, while the rotational shaft 16′ is not connected to the motor 20 and so acts as a driven shaft.

As illustrated in FIGS. 1 and 5, the rotational shafts 16 and 16′ are gear-engaged with timing gears 21 and 21′, respectively. When the motor 20 is activated, the rotational shaft 16 rotates in a rotational direction and the rotational shaft 16′ is rotated in an opposite direction to the rotational shaft 16 via the timing gears 21 and 21′. There is an end cover 26 attached at an axially one end of the side cover 23, as illustrated in FIG. 1. The timing gears 21 and 21′ are accommodated in an oil chamber 26c of the end cover 26. Further, the oil chamber 26c houses oil 27 therein, which lubricates a drive mechanism such as the timing gears 21 and 21′, A sealing member 40 is disposed at a clearance between an outer peripheral surface of the rotational shaft 16 and the side cover 23, while the other sealing member 40 is disposed at a clearance between an outer peripheral surface of the other rotational shaft 16′ and the side cover 23. Therefore, the oil 27 is prevented from approaching the pump chamber 11.

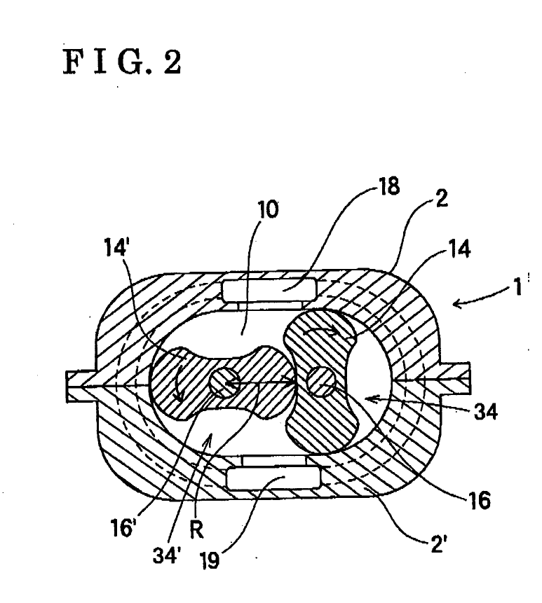

As illustrated in FIG. 2, the pair of rotors 14 and 14′ interacts each other and rotates in one and the other rotational directions, respectively. The gas can be drawn and exhausted in the pump chamber 10 in response to the rotations of the rotors 14 and 14′. In the same manner, the pair of rotors 12 and 12′ interacts each other and rotates in one and the other rotational directions, respectively. The gas can be drawn and exhausted in the pump chamber 8 in response to the rotations of the rotors 12 and 12′. The pair of rotors 13 and 13′ interacts each other and rotates in one and the other rotational directions, respectively. The gas can be drawn and exhausted in the pump chamber 9 in response to the rotations of the rotors 13 and 13′. The pair of rotors 15 and 15′ interacts each other and rotates in one and the other rotational directions, respectively. The gas can be drawn and exhausted in the pump chamber 11 in response to the rotations of the rotors 15 and 15′.

The pair of rotors 14 and 14′ illustrated in FIG. 2 has a small amount of clearance therebetween and so the rotor 14 does not impact with the other rotor 14′. Further, an outer wall surface of each rotor 14 and 14′ has a small amount of clearance relative to an inner wall surface of the pump chamber 10. Therefore, each rotor 14 and 14′ does not impact with the inner wall surface of the pump chamber 10. Contact relationships of the rotors 12, 12′, 13, 13′, 15 and 15′ are the same as described above.

According to the first embodiment of the present invention, an axial movement of the rotational shaft 16 is constrained by the bearing 25 at the main outlet port 4 side and so the rotational shaft 16 can be positioned along the axial direction. In the same manner, an axial movement of the rotational shaft 16′ is constrained by the bearing 25′ at the main outlet port 4 side and so the rotational shaft 16′ can be positioned along the axial direction. Therefore, the bearings 25 and 25′ serve as positioning reference members for positioning the rotational shafts 16 and 16′, respectively. For example, the bearings 25 and 25′ can be double row angular contact bearings as a non-limiting example. Therefore, when the rotational shafts 16 and 16′ expands with heat, the rotational shafts 16 and 16′ displace mainly toward the bearings 24 and 24′, i.e., in an arrow direction Y1 in FIG. 1.

As described above, the load applied to the fourth stage pump chamber 11 is the largest, and the heat of compression generated at the fourth stage pump chamber 11 is the largest. Therefore, the temperature of the fourth stage pump chamber 11 reaches higher than the ones of the other pump chambers 8, 9 and 10. According to the first embodiment of the present invention, the rotational shafts 16 and 16′ are positioned in the axial direction by the bearings 25 and 25′ near the fourth stage pump chamber 11. That is, the bearing 25 restrains the portion of the rotational shaft 16, which is most likely to be heated up and expands with heat, from displacement in the axial direction. In the same manner, the bearing 25′ restrains the portion of the rotational shaft 16′, which is most likely to be heated up and expands with heat, from displacement in the axial direction. Therefore, the structure of the multistage dry pump 1 according to the first embodiment of the present invention is effective to reduce negative influence due to the heat expansion of the rotational shafts 16 and 16′.

Further, as described above, the temperature in the fourth stage pump chamber 11 reaches relatively higher than the ones of the other pump chambers 8, 9 and 10. In light of foregoing, each rotor 15 and 15′ in the fourth stage pump chamber 11 possesses a shorter axial dimension than each rotor in the other pump chambers 8, 9 and 10, thereby enabling to restrain the heat expansion of the rotors 15 and 15′ positioned at a higher temperature side.

Still further, the multistage dry pump 1 according to the first embodiment of the present invention has been further developed based upon the continuous commitments and efforts of the inventors in light of the heat expansion and some occurrences due to the heat expansion. According to a conventional multistage dry pump, the axial dimension of the rotational shaft is longer than a radial dimension thereof (the radial dimension corresponding to a distance R in FIG. 2), and so the heat-expanded amount of the rotor in the axial direction is greater than the one in the radial direction. The experimental results by the inventors of the present invention have confirmed that negative influence due to the heat expansion can be reduced by forming the rotational shaft of which substrate is made of a material with a small linear expansion coefficient, thereby enabling to prevent the rotor from being locked (hereinafter, referred to as rotor lock event).

According to the first embodiment of the present invention, each rotational shaft 16 and 16′ is made of metal of which linear expansion coefficient is less than 6×10⁻⁶ m/m·K inclusive. The more preferable linear expansion coefficient of each rotational shaft 16 and 16′ is less than 4×10⁻⁶ m/m·K inclusive. It is preferable that each rotational shaft 16 and 16′ is made of a substrate of which linear expansion coefficient is less than 3×10⁻⁶ m/m·K inclusive. The more preferable linear expansion coefficient of the substrate is 1×10⁻⁶ m/m·K inclusive. As described above, in order to lowering the linear expansion coefficient of the rotational shaft, the rotational shaft can be a Fe—Ni base alloy as a non-limiting example. A content of Nickel in the Fe—Ni base alloy largely varies the linear expansion coefficient of the rotational shaft. For example, the content of Nickel can be determined within ranges between 10 and 15% of the Fe—Ni base alloy, between 15 and 45%, between 20 and 40% and between 30 and 40% inclusive (“%” concerning the content of Nickel means “weight %” herein). Typical examples of such a Fe—Ni base alloy are Ni-rich austenite material (e.g., austenitic cast iron), an Invar alloy (NI: approx. 32 to 39%), a super Invar alloy comprising Cobalt (Ni: approx. 30 to 34%, and Co: approx. 2 to 8%) and so on.

If each rotational shaft 16 and 16′ is an Invar alloy basis, it is preferable that the Invar alloy has a property of a linear expansion coefficient less than 1.5×10⁻⁶ m/m·K inclusive. If each rotational shaft 16 and 16′ is a super Invar alloy basis, it is preferable that the super Invar alloy has a property of a linear expansion coefficient less than 1.5×10⁻⁷ m/m·K inclusive.

Each rotational shaft 16 and 16′ can be made of a Ni-rich austenite material (e.g., austenitic cast iron) containing Nickel within a range substantially between 30 and 40% inclusive (“%” concerning the content of Nickel means “weight %” herein). To be more precise, if each rotational shaft 16 and 16′ is an austenitic basis (including an austenitic cast iron), it is preferable that the austenitic material includes, on the weight % basis, Carbon at approx. 1.2 to 3.0% inclusive, especially approx. 1.4 to 2.4% inclusive, Nickel at approx. 25 to 45% inclusive, especially approx. 30 to 40%, and Silicon at approx. 0.2 to 5% inclusive, especially approx. 0.5 to 3% inclusive. However, the content of each is not limited to the above. Carbon largely contributes to improve flow property of the solution and can generate graphite. Silicon largely contributes to improve flow property of the solution. If Silicon is contained excessively, Silicon tends to increase the linear expansion coefficient thereof. Therefore, it is more preferable that the austenitic material includes Silicon less than 2.5% inclusive on the weight % basis, especially less than 1.5% inclusive. Typical examples as the graphite shape are flake graphite, spheroidal graphite and so on. Therefore, although the rotational shafts 16 and 16′ extend from the first stage pump chamber 8 to the fourth stage pump chamber 11 with a relatively long axial dimension, the heat expansions of the rotational shafts 16 and 16′ in the axial direction can be effectively restrained.

Further, according to the first embodiment of the present invention, each pump housing 2 and 2′ is made of a material, which is not easily expanded with heat. For example, it is preferable that each pump housing 2 and 2′ has a property of the linear expansion coefficient less than 6×10⁻⁶ m/m·K inclusive. A more preferable linear expansion coefficient thereof is less than 4×10⁻⁶ m/m·K inclusive. A still more preferable liner expansion coefficient thereof is less than 3×10⁻⁶ m/m·K inclusive. A typical example of this type of material is a Fe—Ni base alloy. As described above, the content of Nickel can be determined within ranges between 10 and 15% of the Fe—Ni base alloy, between 15 and 45%, between 20 and 40% inclusive (“%” concerning the content of Nickel means “weight %” herein). Typical examples of such a Fe—Ni base alloy are Ni-rich austenite material (e.g., austenitic base iron), an Invar alloy, a super Invar alloy comprising Cobalt. If the content of Nickel is increased, the heat transfer coefficient of the pump housing can be effectively reduced, and further a corrosion resistance thereof can be effectively improved.

Each pump housing 2 and 2′ can be made of a Ni-rich austenite material (e.g., austenitic cast iron) containing Nickel within a range substantially between 30 and 40% inclusive (“%” concerning the content of Nickel means “weight %” herein). The austenite material can be substituted by a spheroidal graphite cast iron or a flake graphite cast iron. Properties of the spheroidal graphite cast iron tends to be effective in improving corrosion resistance of each housing 2 and 2′, reducing heat transfer coefficient thereof and increasing strength thereof.

Still further, according to the first embodiment of the present invention, each rotor 12, 13, 14 and 15 is made of a metal easily processed and machined, such as aluminum, aluminum base alloy, flake graphite cast iron, spheroidal graphite cast iron, vermicular graphite cast iron, eutectic graphite cast iron and carbon steel as non-limiting examples. Each rotor 12′, 13′, 14′ and 15′ is made in the same manner as described above.

Each rotor 12, 13, 14 and 15 is mated or joined with the outer peripheral portion of the rotational shaft 16, by casting each rotor integrally at the outer peripheral portion thereof, by brazing each rotor at the outer peripheral portion thereof or by pressing the rotor into the rotational shaft 16 (including quench inserting and cool inserting). One rotor initial member is formed as described above. Each rotor 12, 13, 14 and 15 is interconnected substantially in phase to one another in a circumferential direction. Each rotor 12′, 13′, 14′ and 15′ is mated or joined with the outer peripheral portion of the rotational shaft 16′ in the same manner as described above. The other rotor initial member is formed as described above. As aforementioned, each rotor can be easily integrated with the rotational shaft.

By applying a cutting operation to the one rotor initial member with the rotational shaft 16, the rotors 12, 13, 14 and 15, which are parallelly aligned in the axial direction of the rotational shaft 16, are integrally put together so as to form a rotor rotational member 34, In the same manner, by applying a cutting operation to the other rotor initial member with the rotational shaft 16′, the rotors 12′, 13′, 14′ and 15′ are integrally put together so as to form the other rotor rotational member 34′.

On the occasion when the multistage dry pump 1 is used, the gas is drawn from the main intake port 3 of the pump housing 2 in the arrow direction A1. Further, on the occasion when the pump 1 is operated, the rotor rotational member 34 (with the rotational shaft 16, the rotors 12, 13, 14 and 15) and the other rotor rotational member 34′ (with the rotational shaft 16′, the rotors 12′, 13′, 14′ and 15′) are interconnected to each other and rotated in one and the other directions in response to the activation of the motor 20. The gas drawn at the main intake port 3 is compressed at the first stage pump chamber 8 and fed to the second stage pump chamber 9 via the gas transport passage 17. The gas compressed at the second stage pump chamber 9 is fed to the third stage pump chamber 10 via the gas transport passage 18. The gas compressed at the third stage pump chamber 10 is fed to the fourth stage pump chamber 11 via the gas transport passage 19. The gas compressed in sequence as described above is exhausted outside the multistage dry pump 1 in the arrow direction A2 from the main outlet port 4.

When the gas is compressed in sequence at the pump chambers 8, 9, 10 and 11 as described above, heat of compression is generated at each pump chamber. Temperatures of the rotor rotational members 34, 34′ and of the housings 2, 2′ are hence increased. During or after the operation of the multistage dry pump 1, the multistage dry pump 1 is cooled down from outside by use of a water-cooled type device or an air-cooled type device. However, especially when the condensable gas or a gas, which tends to deposit reaction product, is exhausted from the main outlet port 4, it is preferable these gases pass through the inside of the multistage dry pump 1 so as to prevent these gases from being liquefied or condensed. Therefore, it is preferable that the inside of the pump 1 is maintained at a relatively high temperature.

However, when the multistage dry pump 1 is operated while keeping the pump chambers 8, 9, 10 and 11 at relatively high temperature, each housing 2, 2′ and each rotor rotational member 34, 34′ expand with heat based upon each linear expansion coefficient. Especially, comparing with a radial dimension R (shown in FIG. 2) of each rotor 12, 13, 14, is, 12′, 13′, 14′ and 15′, an axial dimension of each rotor rotational member 34 and 34′ is larger. Therefore, in the multistage dry pump 1, each rotor may be locked at the inner wall surface of each pump chamber due to the heat expansion in the axial direction.

According to the first embodiment of the present invention, each rotational shaft 16 and 16′ can be made of a metal material with a relatively small linear expansion coefficient, for example can be made of a Ni-rich austenite material such as austenitic cast iron, thereby enabling to reduce negative influence due to the heat expansion of each rotational shaft. Therefore, even if the temperature in each pump chamber is raised in response to the operation of the multistage dry pump 1, the axially directional heat expansion of each rotational shaft 16 and 16′, which generally tends to be an issue during the operation of the pump 1, can be effectively reduced. Further, heat stress between each rotational shaft and rotor can become less influential, thereby effectively enabling to restrain occurrence of the rotor lock event.

Further, according to the first embodiment of the present invention, each pump housing 2 and 2′ can be made of a material, which is not easily expanded with heat. For example, each pump housing 2 and 2′ can be made of a material of which linear expansion coefficient is relatively small, such as a Ni-rich austenite material (e.g., austenitic cast iron). Namely, not only each rotational shaft 16 and 16′ but also each pump housing 2 and 2′ is made of a material with a relatively small linear expansion coefficient. A clearance or cavity between each rotor and the inner wall surface of each pump chamber can be hence designed small. The compressed gas can be prevented from counter-flowing through this clearance or cavity. Therefore, the multistage dry pump 1 can be operated with a high pumping performance at a relatively high operating temperature even when the condensable gas or a gas, which easily generates reaction product, is exhausted from the main outlet port 4.

The above-described material, Ni-rich austenite material (e.g., austenitic cast iron) with tough property, cannot be easily machined. Further, a machining tool gets easily worn out. Therefore larger requirements in productivity and manufacturing cost have lead to each rotor 12, 13, 14, 15, 12′, 13′, 14′ and 15′, which requires high precision to be formed like a desired shape as illustrated, i.e., to have the two bladed configuration. According to the embodiment of the present invention, each rotor is made of a material which is more easily machined than the austenite material such as the austenitic cast iron, thereby enabling to easily form the rotor having the two bladed configuration with high precision, enabling to improve productivity and enabling to reduce the manufacturing cost.

As illustrated in FIG. 3, the rotor rotational member 34 includes three separating grooves 28, 29 and 30 in this sequence in the axial direction of the rotational shaft 16. The separating groove 28 defined between the rotors 12 and 13 separates a boss member 12b of the rotor 12 and a boss member 13b of the rotor 13. The separating groove 29 defined between the rotors 13 and 14 separates a boss member 13b of the rotor 13 and a boss member 14b of the rotor 14. The separating groove 30 defined between the rotors 14 and 15 separates the boss member 14b of the rotor 14 and a boss member 15b of the rotor 15. Therefore, each rotor 12, 13, 14 and 15 does not always impact with each other. In this case, each rotor 12, 13, 14 and 15 expands with heat individually and so each adjacent rotor can be effectively prevented from being mutually interacted. Therefore, the heat expansion of each rotor 12, 13, 14 and 15 in the axial direction can be effectively restrained, thereby enabling to prevent each rotor 12, 13, 14 and 15 from being locked.

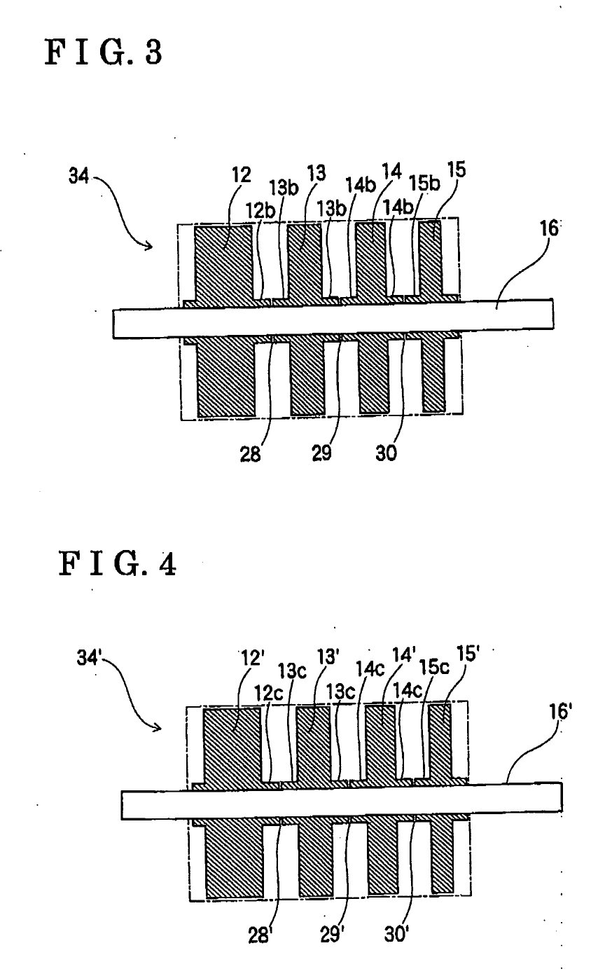

In the same manner, as illustrated in FIG. 4, the other rotor rotational member 34′ includes three separating grooves 28′, 29′ and 30′ in this sequence in the axial direction of the rotational shaft 16′. The separating groove 28′ defined between the rotors 12′ and 13′ separates a boss member 12c of the rotor 12′ and a boss member 13c of the rotor 13′. The separating groove 29′ defined between the rotors 13′ and 14′ separates a boss member 13c of the rotor 13′ and a boss member 14c of the rotor 14′. The separating groove 30′ defined between the rotors 14′ and 15′ separates the boss member 14c of the rotor 14′ and a boss member 15c of the rotor 15′. Therefore, each rotor 12′, 13′, 14′ and 15′ does not always impact with each other. In this case, each rotor 12′, 13′, 14′ and 15′ expands with heat individually and so each adjacent rotor can be effectively prevented from being mutually interacted. Therefore, the heat expansion of each rotor 12′, 13′, 14′ and 15′ in the axial direction can be effectively restrained, thereby enabling to prevent each rotor 12′, 13′, 14′ and 15′ from being locked.

As described above, the small clearance or cavity between each rotor and the inner wall surface of each pump chamber can be still kept small substantially in the same manner as each rotor rotational member, which is entirely made of a Ni-rich austenite material with a relatively small linear expansion coefficient.

According to the first embodiment of the present invention, heat conductivity of each rotational shaft 16 and 16′ is limited less than 20 W/(m·K) inclusive within a temperature range between an ambient temperature and 200 degrees Celsius. The more preferable heat conductivity thereof is less than 15 W/(m·K) inclusive. In this case, heat transmission outwardly via the axial length of each rotational shaft 16 and 16′ can be effectively restrained. Therefore, while keeping the temperature in the pump chambers 8, 9, 10 and 11 relatively high, a portion apart from the pump chambers, such as each bearing 25 and 25′ supporting each rotational shaft 16 and 16′ for rotation, can be maintained at a relatively low temperature.

That is, a temperature gradient is generated, wherein the temperature of the pump chambers 8, 9, 10 and 11 reaches relatively higher and the temperature of axially ends of each pump housing 2 and 2′ stays relatively low. Therefore, the gas in the pump chambers can be effectively prevented from being liquefied and condensed and so the rotors can be prevented from being locked in the pump chambers. Further, the bearings 25 and 25′ of the rotational shaft 16 and 16′ can be effectively prevented from reaching a high temperature and so the bearings 25 and 25′ can support the rotational shafts 16 and 16′ more reliably. Especially, when the austenite material contained in each rotational shaft and pump housing is spheroidal graphite cast iron, the spheroidal shape is preferable in assuring hardness of each component rather than flake graphite cast iron. Further, the spheroidal shape is preferable in reducing the heat conductivity of each rotational shaft and pump housing, and further in raising the operating temperature for pumping operation.

Further, even if the gas drawn at the multistage dry pump 1 is corrosive, each rotational shaft and pump housing, each which is made of corrosive resistant Ni-rich austenite base material, can be corrosive resistant enough against the corrosive gas. Therefore, the clearance or cavity extension due to the corrosion deterioration can be effectively prevented even after a long-running of the multistage dry pump 1. This effectively prevents the counter-flowing of the gas via the clearance. Especially when each rotational shaft and pump housing is made of a spheroidal graphite cast iron, the spheroidal graphite cast iron excels in corrosive resistance rather than a flake graphite cast iron and is very adaptable to a corrosive gas.

Next, following explanation will be given for explaining the multistage dry pump 1 according to a second embodiment of the present invention. The structure of the multistage dry pump 1 according to the second embodiment is substantially the same as the one according to the first embodiment and so as to raise the same effects. The following explanation will be given for explaining a different portion from the first embodiment.

In the multistage dry pump1 according to the second embodiment of the present invention, the gas drawn from the subject chamber 90 via the main intake port 3 is compressed sequentially by the first stage pump chamber 8, the second stage pump chamber 9, the third stage pump chamber 10 and the fourth stage pump chamber 11. In this case, the rotational shafts 16 and 16′ penetrate the dividing walls 5, 6 and 7. The drawn gas may counter-flow in the clearance or cavity at the outer peripheral side of each rotational shaft 16 and 16′, thereby deteriorating the pumping performance.

There are seal rings 31, 32 and 33 disposed at the separating grooves 28, 29 and 30 for the rotor rotational member 34. Further, there are seal rings 32′, 32′ and 33′ disposed at the separating grooves 28′, 29′ and 30′ for the other rotor rotational member 34′. Therefore, pumping performance can be enhanced by decreasing the amount of counter-flowing gas. Each seal ring is made of a soft material. Alternatively, high temperature adhesive can be attached at each separating groove. In this case, each rotor is jointed via the separating groove with the high temperature adhesive.

Following modifications can be applied.

Each rotational shaft and pump housing can be made of a material of which linear expansion coefficient is less than 2×10⁻⁶ m/m·K inclusive. Further, the linear expansion coefficient of each rotor and pump housing can be 0 including 0 and more than 0.

Each rotor is mated or joined with the outer peripheral portion of the rotational shaft 16, by casting each rotor integrally at the outer peripheral portion thereof, by brazing each rotor at the outer peripheral portion thereof or by pressing the rotor into the rotational shaft 16 (including quench inserting and cool inserting). Alternatively, each rotor can be individually cast at the outer peripheral portion of the rotational shaft. Further, each rotor can be individually brazed at the outer peripheral portion of the rotational shaft. Still further, each rotor can be individually pressed into the rotational shaft.

According to the first and second embodiments of the present invention, the profile of each rotor is the two bladed configuration as illustrated. Alternatively, the profile of each rotor can be a three bladed configuration or a clawed configuration. Needless to say, the multistage dry pump 1 can be a three-stage type, a five-stage type, a six-stage type and so on.

According to the first and second embodiments of the present invention, each rotor is made of a metal easily processed and machined, such as aluminum, aluminum base alloy, flake graphite cast iron, spheroidal graphite cast iron, vermicular graphite cast iron, eutectic graphite cast iron and carbon steel as non-limiting examples. In order to further improve corrosion resistance, it is preferable that each rotor is plated with nickel or is coated with resin such as fluorocarbon resin.

According to the first and second embodiments of the present invention, the condensable gas or the gas, which easily deposits reaction product, is preferably drawn at the main intake port 3 and is preferably exhausted at the main outlet port 4. However, some other types of gas can be drawn and exhausted by the multistage dry pump 1.

The principles, the preferred embodiments and mode of operation of the present invention have been described in the foregoing specification. However, the invention which is intended to be protected is not to be construed as limited to the particular embodiment disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A multistage dry pump comprising:
a pump housing having plural pump chambers aligned in parallel;
at least one rotational shaft extending along a parallel alignment direction of the plural pump chambers and rotatably supported by the pump housing; and
plural rotors parallelly aligned in an axial direction of the at least one rotational shaft and furnished in the respective plural pump chambers,
wherein the at least one rotational shaft is formed with a base material of which linear expansion coefficient is less than 6×10⁻⁶ m/m·K inclusive, and the respective plural rotors is made of a material which is more easily machined than the material of the at least one rotational shaft.

2. A multistage dry pump according to claim 1, wherein the respective plural rotors are joined at an outer peripheral portion of the at least one rotational shaft by being integrally cast at the outer peripheral portion thereof, by being brazed at the outer peripheral portion thereof or by being pressed into the at least one rotational shaft.

3. A multistage dry pump according to claim 2, wherein the respective plural rotors adjacent to each other in the axial direction of the at least one rotational shaft are parallelly aligned so as to be mutually separated at a separating portion.

4. A multistage dry pump according to claim 1, wherein the pump housing housing the plural rotors and the at least one rotational shaft therein is made of a material of which linear expansion coefficient is less than 6×10⁻⁶ m/m·K inclusive.

5. A multistage dry pump according to claim 1, wherein there is a sealing member disposed between the plural rotors mutually adjacently aligned in the axial direction of the at least one rotational shaft.

6. A multistage dry pump according to claim 3, wherein there is a sealing member disposed between the plural rotors mutually adjacently aligned in the axial direction of the at least one rotational shaft.

7. A multistage dry pump according to claim 6, wherein the sealing member is disposed at the separating portion.

8. A multistage dry pump according to claim 1, wherein the at least one rotational shaft is made of a base material of a Fe—Ni basis alloy.

9. A multistage dry pump according to claim 8, wherein the Fe—Ni basis alloy is an austenite material containing an iron as a main component, a nickel at approximately 25 to 45 weight %, a carbon approximately 1.2 to 3 weight % and a silicon at approximately 0.2 to 5 weight %.

10. A multistage dry pump according to claim 1, wherein the respective plural rotors are made of at least one of aluminum, an aluminum alloy, a flake graphite cast iron, a spheroidal graphite cast iron, a vermicular graphite cast iron, an eutectic graphite cast iron, a carbon steel.

11. A multistage dry pump according to claim 8, wherein the respective plural rotors are made of at least one of aluminum, an aluminum alloy, a flake graphite cast iron, a spheroidal graphite cast iron, a vermicular graphite cast iron, an eutectic graphite cast iron, a carbon steel.

12. A multistage dry pump according to claim 9, wherein the respective plural rotors are made of at least one of aluminum, an aluminum alloy, a flake graphite cast iron, a spheroidal graphite cast iron, a vermicular graphite cast iron, an eutectic graphite cast iron, a carbon steel.

13. A multistage dry pump comprising:
a pump housing having plural pump chambers aligned in parallel;
at least one rotational shaft extending along a parallel alignment direction of the plural pump chambers and rotatably supported by the pump housing; and
plural rotors integrally provided with the at least one rotational shaft and parallelly aligned in an axial direction of the at least one rotational shaft, the plural rotors housed in the respective plural pump chambers,
wherein the at least one rotational shaft is made of a base material of a Fe—Ni basis alloy of which linear expansion coefficient is less than 6×10⁻⁶ m/m·K inclusive, the respective plural rotors is made of at least one of aluminum, an aluminum alloy, a flake graphite cast iron, a spheroidal graphite cast iron, a vermicular graphite cast iron, an eutectic graphite cast iron, a carbon steel, and the respective plural rotors are joined at an outer peripheral portion of the at least one rotational shaft by being integrally cast at the outer peripheral portion thereof, by being brazed at the outer peripheral portion thereof or by being pressed into the at least one rotational shaft.

14. A multistage dry pump according to claim 13, wherein the respective plural rotors adjacent to each other in the axial direction of the at least one rotational shaft are parallelly aligned so as to be mutually separated at a separating portion.

15. A multistage dry pump according to claim 13, wherein the pump housing housing the plural rotors and the at least one rotational shaft therein is made of a material of which linear expansion coefficient is less than 6×10⁻⁶ m/m·K inclusive.

16. A multistage dry pump according to claim 13, wherein there is a sealing member disposed between the plural rotors mutually adjacently aligned in the axial direction of the at least one rotational shaft.

17. A multistage dry pump according to claim 14, wherein there is a sealing member disposed between the plural rotors mutually adjacently aligned in the axial direction of the at least one rotational shaft.

18. A multistage dry pump according to claim 17, wherein the sealing member is disposed at the separating portion.

19. A multistage dry pump according to claim 13, wherein the Fe—Ni basis alloy is an austenite material containing an iron as a main component, a nickel at approximately 25 to 45 weight %, a carbon approximately 1.2 to 3 weight % and a silicon at approximately 0.2 to 5 weight %.
